(19) United States
(12) Patent Application Publication
(10) Pub. No.: US 2014/0293019 A1
(43) Pub. Date: Oct. 2, 2014

(54) APPARATUS AND METHOD FOR PRODUCING STEREOSCOPIC SUBTITLES BY ANALYZING THREE-DIMENSIONAL (3D) SPACE

(71) Applicant: Electronics and Telecommunications Research Institute, Daejeon (KR)

(72) Inventors: Kyung Ho JANG, Daegu (KR); Hae Dong KIM, Daejeon (KR); Ho Wook JANG, Daejeon (KR); Seung Woo NAM, Daejeon (KR); Jung Jae YU, Seongnam-si (KR); Myung Ha KIM, Daejeon (KR); Su Ran PARK, Seoul (KR)

(73) Assignee: Electronics and Telecommunications Research Institute, Daejeon (KR)

(21) Appl. No.: 14/161,932

(22) Filed: Jan. 23, 2014

(30) Foreign Application Priority Data
Apr. 1, 2013 (KR) 10-2013-0035313

(51) Int. Cl. H04N 13/00

(52) U.S. Cl. CPC H04N 13/007; H04N 13/0007
USPC 348/51

(57) ABSTRACT

An apparatus and method of producing stereoscopic subtitles by analyzing a three-dimensional (3D) space is disclosed, the apparatus including a camera position calculator to calculate a position of a first camera and a position of a second camera from a first image and a second image, respectively, a subtitle flat arranger to arrange a subtitle flat using a viewing direction of the first camera and a viewing direction of the second camera at the calculated positions, and a subtitle producer to produce subtitles using the subtitle flat.

### CROSS-REFERENCE TO RELATED APPLICATION

This application claims the priority benefit of Korean Patent Application No. 10-2013-0035313, filed on Apr. 1, 2013, in the Korean Intellectual Property Office, the disclosure of which is incorporated herein by reference.

### BACKGROUND

1. Field

The present invention relates to technology for calculating positions of a first camera and a second camera from a first image and a second image, and producing stereoscopic subtitles through arranging a subtitle flat based on the calculated positions.

2. Description of the Related Art

When subtitles are displayed on a stereoscopic image, a two-dimensional (2D) image may be disposed on a left image and a right image obtained through two cameras. Such a scheme may require a complex procedure for determining and verifying positions of the subtitles of the left and right images.

Accordingly, there is a need for technology for automatically designating the positions of subtitles in other images through arranging a subtitle flat in a foreground of a camera by analyzing a three-dimensional (3D) space, and projecting an image of which the positions of subtitles are determined from among the left and right images.

### SUMMARY

An aspect of the present invention provides a method of analyzing a three-dimensional (3D) space including a camera, arranging a subtitle flat in a foreground of the camera, and adjusting a position of the subtitle flat based on a user input.

Another aspect of the present invention also provides a method of setting a virtual center camera between two cameras for obtaining a stereoscopic image, and adjusting the subtitle flat based on the virtual center camera.

According to an aspect of the present invention, there is provided an apparatus for producing stereoscopic subtitles, the apparatus including a camera position calculator to calculate positions of a first camera and a second camera from a first image and a second image, respectively, a subtitle flat arranger to arrange a subtitle flat, using a viewing direction of the first camera and a viewing direction of the second camera at the calculated positions, and a subtitle producer to produce subtitles using the subtitle flat.

According to another aspect of the present invention, there is provided a method of producing stereoscopic subtitles, the method including calculating positions of a first camera and a second camera from a first image and a second image, respectively, arranging a flat subtitle using a viewing direction of the first camera and a viewing direction of the second camera at the calculated positions, and producing subtitles using the flat subtitle.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of an apparatus for producing stereoscopic subtitles according to an embodiment of the present invention;

FIG. 2 is a diagram illustrating an example of calculating positions of cameras according to an embodiment of the present invention;

FIG. 3 is a diagram illustrating an example of arranging a subtitle flat according to an embodiment of the present invention;

FIG. 4 is a diagram illustrating an example of a virtual center camera according to an embodiment of the present invention;

FIG. 5 is a diagram illustrating an example of producing subtitles according to an embodiment of the present invention; and

FIG. 6 is a flowchart illustrating a method of producing stereoscopic subtitles according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

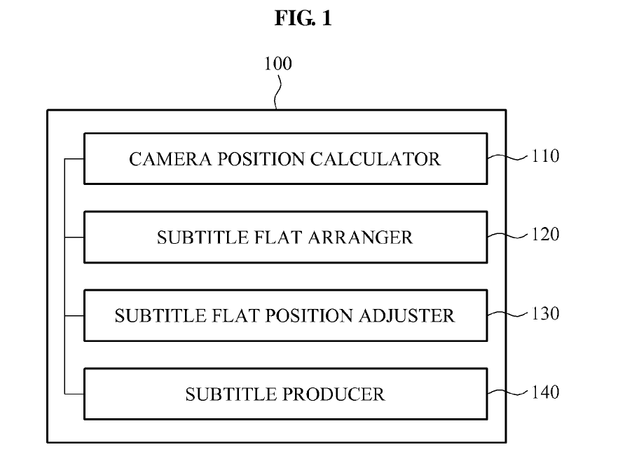

FIG. 1 is a diagram illustrating a configuration of an apparatus 100 for producing stereoscopic subtitles according to an embodiment of the present invention.

Referring to FIG. 1, the apparatus 100 for producing the stereoscopic image may include a camera position calculator 110, a subtitle flat arranger 120, a subtitle flat position adjuster 130, and a subtitle producer 140.

The camera position calculator 120 may calculate positions of a first camera and a second camera from a first image and a second image. The first image and the second image may include two-dimensional (2D) points corresponding to one another, and be merged into one another to configure a stereoscopic image.

The camera position calculator 120 may extract the corresponding 2D points from the first image and the second image, and calculate the positions of the first camera and the second camera through a correction algorithm using the 2D points. As used herein, “the correction algorithm” may refer to an algorithm for correcting an error of a time-gap between the first camera and the second camera and an intersection point of the first camera and the second camera calculated from the 2D points. The 2D points of the first image and the second image may be represented as three-dimensional (3D) points present in front of the first camera and the second camera in a 3D space.

The camera position calculator 120 may calculate a time difference between the 2D points, and obtain the time-gap between the first camera and the second camera.

Also, the camera position calculator 120 may search for focuses of the first image and the second image, and calculate the intersection point at which viewing directions of the first camera and the second camera intersect one another. The camera position calculator 120 may calculate the positions of the first camera and the second camera using the time-gap and the intersection point, and display the positions in a stereoscopic manner along with the 3D points.

The subtitle flat arranger 120 may arrange a subtitle flat using the viewing directions of the first camera and the second camera at the calculated positions. The first camera and the second camera may include multiple viewing directions facing multiple 3D points. Viewing directions facing the first camera and the second camera directly from among the multiple viewing directions may be determined to be a focus of the first camera and a focus of the second camera, respectively.

The subtitle flat arranger 120 may arrange the subtitle flat including a point at which the focus of the first camera and the focus of the second camera intersect, hereinafter referred to as “a point of intersection”. The subtitle flat may refer to a screen to which an image including subtitles is projected. The subtitle flat arranger 120 may set a ratio of width to length of the subtitle flat to be identical to a ratio of width to length of the first image and the second image.

The subtitle flat arranger 120 may arrange the subtitle flat for a virtual line connecting the point of intersection to a center of the position of the first camera and the position of the second camera to be vertical to the subtitle flat. The positions of the first camera and the second camera may correspond to a center of a lens.

The subtitle flat arranger 120 may calculate the center of the first camera and the second camera based on the center of the lens by the camera position calculator 120. In a subsequent step, the subtitle flat arranger 120 may verify whether the virtual line connecting the point of intersection to the center is vertical to the subtitle flat.

The subtitle flat position adjuster 130 may set a virtual center camera from the positions of the first camera and the second camera, and based on the virtual center camera, adjust a position of the subtitle flat. The virtual center camera may be set in the center of the first camera and the second camera, and face the subtitle flat directly.

The subtitle flat position adjuster 130 may generate a plurality of virtual cameras between the position of the first camera and the position of the second camera based on interpolation, and from among the plurality of generated cameras, set a virtual camera vertically facing a center of the subtitle flat to be the virtual center camera. The interpolation may refer to a scheme of calculating a position of a virtual center camera using respective positions of a first camera and a second camera and a distance between the first camera and the second camera when the position of the virtual center camera is yet to be determined.

The subtitle flat position adjuster 130 may adjust an arrangement position of the subtitle flat within a viewing range of the virtual center camera when the position of the subtitle flat does not satisfy predetermined conditions. In this instance, the predetermined conditions may refer to whether a quality of subtitles produced on the subtitle flat by the subtitle producer 140, to be described later, exceeds a limit. By way of example, when subtitles produced on a subtitle flat at an initial arrangement position are blurred or overlap due to being out of focus, the subtitle flat position adjuster 130 may determine that the quality of the subtitles exceeds the limit, and adjust a foreground and background or left and right of the arrangement position of the subtitle flat.

The subtitle flat position adjuster 130 may match a focus of the virtual center camera and the center of the subtitle flat to adjust the subtitle flat to be close to or distant from the virtual center camera.

The subtitle flat position adjuster 130 may display an image captured by at least one of the first camera and the second camera, for example, via a display (not shown), as the arrangement position of the subtitle flat is adjusted. The subtitle flat position adjuster 130 may adjust the position of the subtitle flat based on an input of a user verifying the image.

The subtitle flat position adjuster 130 may display a stereoscopic image created by combining the first image and the second image, for example, via a display. The subtitle flat position adjuster 130 may display a 3D point more adjacent to the virtual center camera than to the subtitle flat from among 3D points within the stereoscopic image, differently from other 3D points among the 3D points within the stereoscopic image. For example, the subtitle flat position adjuster 130 may display, in red, the 3D point more adjacent to the virtual center camera than to the subtitle flat, and the other 3D points in blue.

The subtitle producer 140 may produce subtitles using the subtitle flat. When a first position within the first image in which the subtitles are displayed is determined by the user, the subtitle producer 140 may project the first position to the subtitle flat, calculate a second position within the subtitle flat, re-project the calculated second position to the second image, and determine a third position at which the subtitles in the second image are displayed.

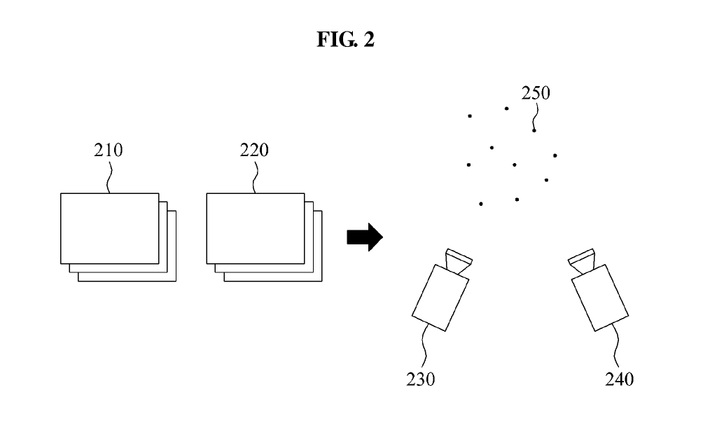

FIG. 2 is a diagram illustrating an example of calculating positions of cameras according to an embodiment of the present invention.

Referring to FIG. 2, an apparatus for producing stereoscopic subtitles may calculate positions of a first camera 230 and a second camera 240 from a first image 210 and a second image 220, respectively. The first image 210 and the second image 220 may be configured by a plurality of frames based on an image length, and a stereoscopic image may be configured by including 2D points corresponding to one another.

The apparatus for producing the stereoscopic subtitles may calculate a time difference between the 2D points corresponding to one another in the first image 210 and the second image 220. The time difference may occur when the first camera 230 and the second camera 240 are arranged in a row and a predetermined time-gap between the first camera 230 and the second camera 240 is present. The apparatus for producing the stereoscopic subtitles may merge the first image 210 and the second image 220, calculate the time difference, and calculate the time-gap.

The apparatus for producing the stereoscopic image may obtain a point at which the time difference is zero in the first image 210 and the second image 220, and verify a point at which a focus of the first camera 230 and a focus of the second camera 240 intersect.

The first camera 230 and the second camera 240 may face a 3D point 250 in multiple viewing directions. In this instance, the focus of the first camera 230 and the focus of the second camera 240 may face the identical 3D point 250 through intersecting one another. In this example, the first camera 230 may face a left-hand side of the 3D point 250 while the second camera 240 may face a right-hand side of the 3D point 250. The apparatus for producing the stereoscopic subtitles may calculate a distance from the 3D point 250 to the first camera 230 and the second camera 240 through the point at which the focuses intersect.

The apparatus for producing the stereoscopic image may calculate a position of the first camera 230 and a position of the second camera 240 through a correction algorithm using 2D points extracted from the first image 210 and the second image 220. As used herein, “the correction algorithm” may refer to an algorithm for correcting an error of a time-gap between the first camera 230 and the second camera 240 and an intersection point of the first camera 230 and the second camera 240 calculated from the 2D points. For example, when the positions of the first camera 230 and the second camera 240 are calculated, the apparatus for producing the stereoscopic subtitles may substitute values of the positions into equations designed, perform reverse deduction on the time-gap and the intersection point, and perform comparison operation.

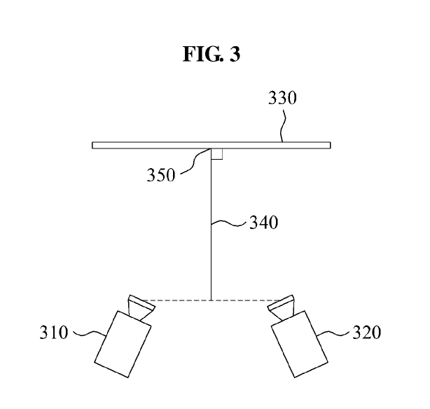

FIG. 3 is a diagram illustrating an example of arranging a subtitle flat 330 according to an embodiment of the present invention.

An apparatus for producing stereoscopic subtitles may calculate a position of a first camera 310 and a position of a second camera 320 from a first image and a second image, and arrange the subtitle flat 330. In this instance, the apparatus for producing the stereoscopic subtitles may use a viewing direction of the first camera 310 and a viewing direction of the second camera 320.

The apparatus for producing the stereoscopic subtitles may arrange the subtitle flat 330 by including a point 350 at which a focus of the first camera 310 and a focus of the second camera 320 intersect, hereinafter referred to as “a point of intersection 350”. As used herein, “the focus” may refer to a viewing direction to which a center of a lens faces among the viewing directions of the first camera 310 and the second camera 320. When the first camera 310 and the second camera 320 are arranged in a row, a time-gap between the first camera 310 and the second camera 320 may become narrower in a direction toward lenses of the first camera 310 and the second camera 320. Transitively, the focuses of the first camera 310 and the second camera 320 may intersect at an identical 3D point.

The apparatus for producing the stereoscopic subtitles may arrange the subtitle flat 330 by including the point of intersection 350 at which the focus of the first camera 310 and the focus of the second camera 320 intersect. When a stereoscopic image is created by the first camera 310 and the second camera 320, a 3D point present in a foreground of the subtitle flat 330 may appear convex when compared to subtitles, and a 3D point present in a background may appear concave, thereby creating a sense of dimension.

The apparatus for producing the stereoscopic subtitles may set a size of the subtitle flat 330. The apparatus for producing the stereoscopic subtitles may set the size of the subtitle flat 330 to be proportional to screen sizes of the first camera 310 and the second camera 320.

Also, the apparatus for producing the stereoscopic subtitles may arrange the subtitle flat 330 for a virtual line 340 connecting the point of intersection 350 to a center of the position of the first camera 310 and the position of the second camera 320 to be vertical to the subtitle flat 330.

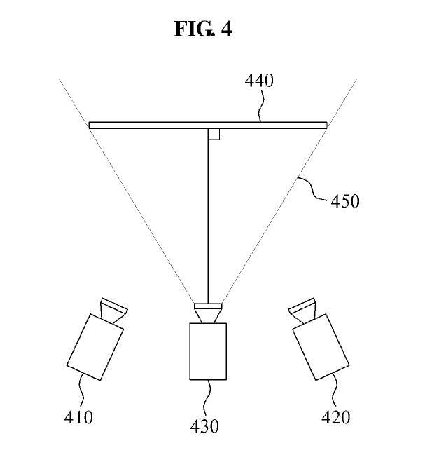

FIG. 4 is a diagram illustrating an example of a virtual center camera 430 according to an embodiment of the present invention.

Referring to FIG. 4, an apparatus for producing stereoscopic subtitles may set the virtual center camera 430 from positions of a first camera 410 and a second camera 420, and based on the virtual center camera 430, adjust a position of a subtitle flat 440.

The apparatus for producing the stereoscopic subtitles may generate a plurality of virtual cameras between the position of the first camera 410 and the position of the second camera 420, and from among the plurality of generated virtual cameras, set a virtual camera vertically facing the subtitle flat 440 to be the virtual center camera 430 based on interpolation. The interpolation may refer to a scheme of calculating a position of a virtual center camera using respective positions of a first camera and a second camera and a distance between the first camera and the second camera when the position of the virtual center camera is yet to be determined.

The apparatus for producing the stereoscopic subtitles may designate the position of the virtual center camera 430 to be a center of the first camera 410 and the second camera 420 to match an intersection point of a stereoscopic image and a center of the subtitle flat 440. The apparatus for producing the stereoscopic subtitles may set a position of the virtual center camera 430 to be a variable. For example, when a distance between the first camera 410 and the second camera 420 is 6, a distance from the first camera 410 to the virtual center camera 430 and a distance from the second camera 420 to the virtual center camera 430 may be 3.

The apparatus for producing the stereoscopic subtitles may calculate the position of the virtual center camera 430 based on position values of the first camera 410 and the second camera 420 and the distance between the first camera 410 and the second camera 420.

When the position of the subtitle flat 440 does not satisfy predetermined conditions, the apparatus for producing the stereoscopic subtitles may adjust an arrangement position of the subtitle flat 440 within a viewing range 450 of the virtual center camera 430.

The apparatus for producing the stereoscopic subtitles may maintain the size of the subtitle flat 440 not to exceed the viewing range 450 of the virtual center camera 430, and adjust the subtitle flat 440 to be close to or distant from the virtual center camera 430.

The apparatus for producing the stereoscopic subtitles may display an image captured by at least one of the first camera 410 and the second camera 420 as the arrangement position of the subtitle flat 440 is adjusted to the virtual center camera 430.

Also, the apparatus for producing the stereoscopic subtitles may display a stereoscopic image created by combining the first image and the second image. The apparatus for producing the stereoscopic subtitles may display a 3D point more adjacent to the virtual center camera 430 than to the subtitle flat 440, from among 3D points within the stereoscopic image, differently from other 3D points among the 3D points within the stereoscopic image. For example, the apparatus for producing the stereoscopic subtitles may display, in red, the 3D point adjacent to the virtual center camera 430, and display the other 3D points in blue.

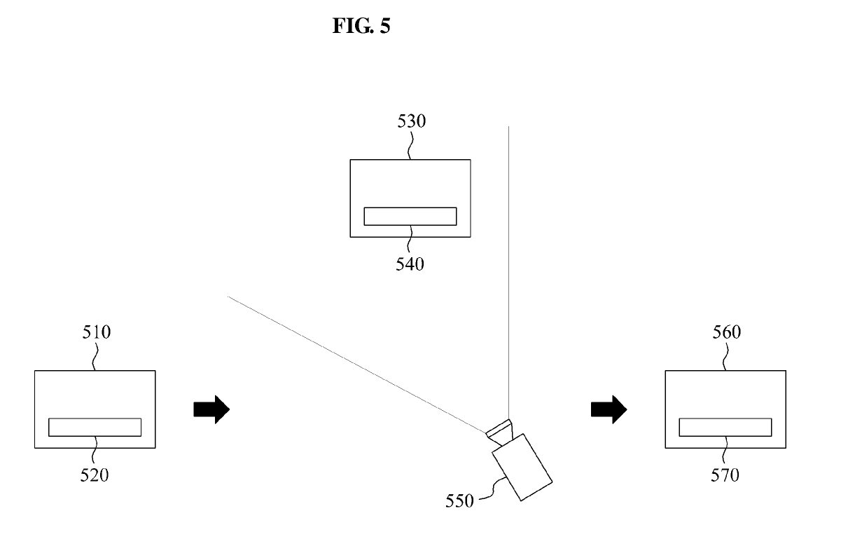

FIG. 5 is a diagram illustrating an example of producing subtitles according to an embodiment of the present invention.

Referring to FIG. 5, an apparatus for producing stereoscopic subtitles may produce subtitles as a position of a subtitle flat 530 is designated in a foreground of a first camera, and a second camera 550 and the subtitle flat 530 are arranged.

The apparatus for producing the stereoscopic subtitles may determine a first position 520 in an area in which the subtitles are displayed in a first image 510 obtained from the first camera.

When the first position 520 is determined by a user, the apparatus for producing the stereoscopic subtitles may display the first position 520 as a rectangular area in the first image 510, and the first position 520 may include an upper left position and a lower right position.

The apparatus for producing the stereoscopic subtitles may project the determined first position 520 to the subtitle flat 530, and calculate a second position 540. The apparatus for producing the stereoscopic subtitles may calculate the upper left position and the lower right position of the first position 520 by setting an upper left position of the first image 510 to be zero. For example, when a width of the first image 510 is “100”, and a length of the first image 510 is “120”, the apparatus for producing the stereoscopic subtitles may represent the upper left position of the first position 520 as a coordinate value of (20, 60), and the lower right position of the first position 520 as a coordinate value of (100, 90). When the coordinate values are calculated, the apparatus for producing the stereoscopic subtitles may calculate an upper left position and a lower right position of the second position 540 based on a size ratio of the first image 510 and the subtitle flat 530.

When the second position 540 is designated, the apparatus for producing the stereoscopic subtitles may capture the subtitle flat 530 via the second camera 550, and re-project the second position 540 to a second image 560. A third position 570 may be automatically designated in the second image 560 of which a ratio of a screen size is identical to a ratio of a screen size of the subtitle flat 530.

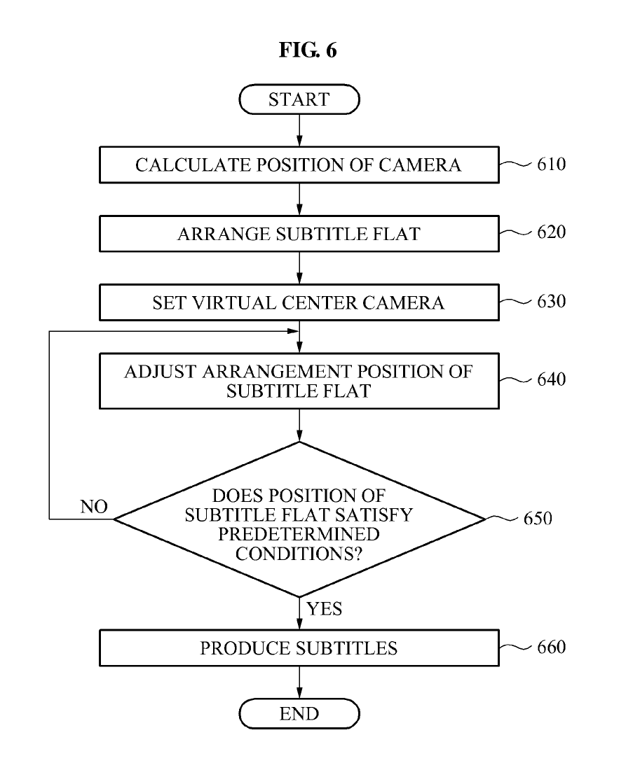

FIG. 6 is a flowchart illustrating a method of producing stereoscopic subtitles according to an embodiment of the present invention.

Referring to FIG. 6, in operation 610, an apparatus for producing stereoscopic subtitles may calculate positions of a first camera and a second camera from a first image and a second image. The apparatus for producing the stereoscopic subtitles may extract 2D points corresponding to one another from the first image and the second image, and calculate the positions of the first camera and the second camera through a correction algorithm using the 2D points. As used herein, “the correction algorithm” may refer to an algorithm for correcting an error of a time-gap between the first camera and the second camera and an intersection point of the first camera and the second camera calculated from the 2D points.

The apparatus for producing the stereoscopic subtitles may calculate a time difference between the 2D points, obtain the time-gap between the first camera and the second camera, and calculate a point at which a focus of the first camera and a focus of the second camera intersect, hereinafter referred to as a “point of intersection”. The apparatus for producing the stereoscopic subtitles may calculate the positions of the first camera and the second camera using the time-gap and the point of intersection.

Also, in operation 620, the apparatus for producing the stereoscopic subtitles may arrange a subtitle flat using a viewing direction of the first camera and a viewing direction of the second camera at the calculated positions. The apparatus for producing the stereoscopic subtitles may arrange the subtitle flat by including a point at which the focus of the first camera and the focus of the second camera intersect. Further, the apparatus for producing the stereoscopic subtitles may arrange the subtitle flat for a virtual line connecting the point of intersection to a center of the position of the first camera and the position of the second camera to be vertical to the subtitle flat. The positions of the first camera and the second camera may refer to a center of a lens.

The apparatus for producing the stereoscopic subtitles may set a virtual center camera from the positions of the first camera and the second camera. The apparatus for producing the stereoscopic subtitles may generate a plurality of virtual cameras between the position of the first camera and the position of the second camera based on interpolation, and from among the plurality of generated cameras, set a virtual camera vertically facing a center of the subtitle flat to be the virtual center camera.

In operation 640, the apparatus for producing the stereoscopic subtitles may adjust the position of the subtitle flat based on the virtual center camera. The interpolation may refer to a scheme of calculating a position of a virtual center camera using respective positions of a first camera and a second camera and a distance between the first camera and the second camera when the position of the virtual center camera is yet to be determined The apparatus for producing the stereoscopic subtitles may display an image captured by at least one of the first camera and the second camera as an arrangement position of the subtitle flat is adjusted. Also, the apparatus for producing the stereoscopic subtitles may display a stereoscopic image created by combining the first image and the second image. In addition, the apparatus for producing the stereoscopic subtitles may display a 3D point more adjacent to the virtual center camera than to the subtitle flat, from among 3D points within the stereoscopic image, differently from other 3D points among the 3D points within the stereoscopic image.

In operation 650, the apparatus for producing the stereoscopic subtitles may determine whether the position of the subtitle flat satisfies predetermined conditions. When the position of the subtitle flat does not satisfy the predetermined conditions, as indicated by the “No” direction in operation 650, the apparatus for producing the stereoscopic subtitles may re-adjust the arrangement position of the subtitle flat within a viewing range of the virtual center camera in operation 640. The apparatus for producing the stereoscopic subtitles may match a focus of the virtual center camera and a center of the subtitle flat, and adjust the arrangement position of the subtitle flat to be close to or distant from the virtual center camera.

When the position of the subtitle flat satisfies the predetermined conditions, as indicated by the “Yes” direction in operation 650, the apparatus for producing the stereoscopic subtitles may produce subtitles using the subtitle flat in operation 660. When a first position within the first image in which the subtitles are displayed is determined by a user, the apparatus for producing the stereoscopic subtitles may project the first position to the subtitle flat, calculate a second position within the subtitle flat, re-project the calculated second position to the second image, and determine a third position at which the subtitles in the second image are displayed.

According to the present exemplary embodiment, it is possible to arrange subtitles on left and right images configuring a stereoscopic image through capturing, by a camera, a subtitle flat to which subtitles of which positions are determined is projected.

According to the present exemplary embodiment, it is possible to verify and change depth of subtitles in a stereoscopic image via simulation of subtitle flat arrangement adjusted based on two cameras.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for producing stereoscopic subtitles, the apparatus comprising:
a camera position calculator to calculate positions of a first camera and a second camera from a first image and a second image, respectively;
a subtitle flat arranger to arrange a subtitle flat, using a viewing direction of the first camera and a viewing direction of the second camera at the calculated positions; and
a subtitle producer to produce subtitles using the subtitle flat.

2. The apparatus of claim 1, wherein the subtitle flat arranger arranges the subtitle flat by including a point at which a focus of the first camera and a focus of the second camera intersect.

3. The apparatus of claim 2, wherein the subtitle flat arranger arranges the subtitle flat for a virtual line connecting the point of intersection to a center of the position of the first camera and the position of the second camera to be vertical to the subtitle flat.

4. The apparatus of claim 1, further comprising:
a subtitle flat position adjustor to set a virtual center camera from the calculated positions, and based on the virtual center camera, adjust an arrangement position of the subtitle flat.

5. The apparatus of claim 4, wherein the subtitle flat position adjustor generates a plurality of virtual cameras between the position of the first camera and the position of the second camera based on interpolation, and among the plurality of generated virtual cameras, sets a virtual camera vertically facing a center of the subtitle flat to be the virtual center camera.

6. The apparatus of claim 4, wherein the subtitle flat position adjustor adjusts the arrangement position of the subtitle flat within a viewing range of the virtual center camera when the arrangement position of the subtitle flat does not satisfy predetermined conditions.

7. The apparatus of claim 4, wherein the subtitle flat position adjustor displays a three-dimensional (3D) point more adjacent to the virtual center camera than to the subtitle flat, from among 3D points within a stereoscopic image created by combining the first image and the second image, differently from other 3D points among the 3D points within the stereoscopic image.

8. The apparatus of claim 4, wherein the subtitle flat position adjustor displays an image captured by at least one of the first camera and the second camera as the arrangement position of the subtitle flat is adjusted.

9. The apparatus of claim 1, wherein when a first position within the first image in which the subtitles are displayed is determined, the subtitle producer projects the first position to the subtitle flat, calculates a second position within the subtitle flat, re-projects the calculated second position to the second image, and determines a third position at which the subtitles in the second image is displayed.

10. The apparatus of claim 1, wherein the camera position calculator extracts two-dimensional (2D) points corresponding to one another from the first image and the second image, and calculates the position of the first camera and the position of the second camera through a correction algorithm using the 2D points.

11. A method of producing stereoscopic subtitles, the method comprising:
calculating positions of a first camera and a second camera from a first image and a second image, respectively;
arranging a flat subtitle using a viewing direction of the first camera and a viewing direction of the second camera at the calculated positions; and
producing subtitles using the flat subtitle.

12. The method of claim 11, wherein the arranging of the subtitle flat comprises:
arranging the subtitle flat by including a point at which a focus of the first camera and a focus of the second camera intersect.

13. The method of claim 12, wherein the arranging of the subtitle flat further comprises:
arranging the subtitle flat for a virtual line connecting the point to a center of the position of the first camera and the position of the second camera to be vertical to the subtitle flat.

14. The method of claim 11, further comprising:
setting a virtual center camera from the calculated positions; and
adjusting an arrangement position of the subtitle flat, based on the virtual center camera.

15. The method of claim 14, wherein the setting of the virtual center camera comprises:
generating a plurality of virtual cameras between the position of the first camera and the position of the second camera based on interpolation; and
setting a virtual camera vertically facing a center of the subtitle flat to be the virtual center camera from among the plurality of generated virtual cameras.

16. The method of claim 14, wherein the adjusting of the arrangement position of the subtitle flat comprises:
adjusting the arrangement position of the subtitle flat within a viewing range of the virtual center camera when the arrangement position of the subtitle flat does not satisfy predetermined conditions.

17. The method of claim 14, further comprising:
displaying a three-dimensional (3D) point more adjacent to the virtual center camera than to the subtitle flat, from among 3D points within a stereoscopic image created by combining the first image and the second image, differently from other 3D points among the 3D points within the stereoscopic image.

18. The method of claim 14, further comprising:
displaying an image captured by at least one of the first camera and the second camera as the arrangement position of the subtitle flat is adjusted.

19. The method of claim 11, wherein when a first position within the first image in which the subtitles are displayed is determined, the producing of the subtitles comprises:
projecting the first position to the subtitle flat, and calculating a second position within the subtitle flat; and
re-projecting the calculated second position to the second image, and determining a third position at which the subtitles in the second image are displayed.

20. The method of claim 11, wherein the calculating of the positions of the first camera and the second camera comprises:
extracting two-dimensional (2D) points corresponding to one another from the first image and the second image, and calculating the position of the first camera and the position of the second camera through a correction algorithm using the 2D points.
